(19) United States
(12) Patent Application Publication
(10) Pub. No.: US 2005/0049049 A1
(43) Pub. Date: Mar. 3, 2005

(54) Cocktail table

(75) Inventors: Chan Griswold, Reno, NV (US); Sonny Mattice, Gardenerville, NV (US); Richard Wilder, Sparks, NV (US)

Correspondence Address: BEYER WEAVER & THOMAS LLP, P.O. BOX 70250, OAKLAND, CA, 94612-0250, US

(73) Assignee: IGT

(21) Appl. No.: 10/649,352

(22) Filed: Aug. 26, 2003

(51) Int. Cl. A63F 13/00

(52) U.S. Cl. 463/46

(57) ABSTRACT

Methods and apparatus are presented for a gaming machine cocktail table. In some instances, it can include a cocktail table chassis and one or more display screens mounted in the cocktail table chassis. The display screens can face generally upward for viewing by two or more players seated proximate the cocktail table chassis. A master gaming controller can be connected to each of the display screens and can control games presented on each of the display screens. In some applications, a monolithic tabletop can be provided on the cocktail table chassis to cover components of the gaming machine, whereby player interaction with any of these gaming machine components is via the monolithic tabletop, thereby isolating the gaming machine components from environmental contamination. Some of the gaming components can include items such as an image redirect sheet for redirecting light emitted from the display screen in a direction generally toward where the player is expected to be seated, a wireless credit device for receiving credit for game play, and a touch pad for receiving player selections associated with game play.

### BACKGROUND OF THE INVENTION

I. Field of the Invention

The present invention relates to gaming machines such as traditional slot machines, video slot machines, video poker machines, and video keno machines. More particularly, the present invention relates to methods and apparatus for providing a gaming machine configured as a cocktail table.

II. Background

Typically, utilizing a master gaming controller, a gaming machine controls various combinations of devices that encourage game play on the gaming machine and allow a player to play a game of chance. A game played on a gaming machine usually requires a player to input money or indicia of credit into the gaming machine, indicate a wager amount, and initiate game play. These steps typically require the gaming machine to control input devices, such as bill validators and coin acceptors, to accept money and/or credits into the gaming machine, and recognize user inputs from devices, including key pads and button pads, to determine the wager amount and initiate game play. After game play has been initiated, the gaming machine determines a game outcome, presents the game outcome to the player and may dispense an award of some type depending on the particular game outcome.

Within a casino or other gaming environment, it is common for players to consume food and/or beverages on or around the gaming machines. Many casinos serve complimentary beverages to players at gaming machines in order to enhance the players' enjoyment and encourage further game play. However, consumption of food and beverages on and around gaming machines can be inconvenient for both the players and the casinos. For instance, players may not have a level and conveniently accessible surface upon which to place their food and beverage items. Furthermore, when food or beverage products are spilled on the gaming machines, the gaming machines can malfunction or require significant clean-up, resulting in downtime and possibly special servicing. Specifically, if food or beverages fall within input/output devices or other areas of the gaming machine that lead to electrical or mechanical components, such contamination can cause the electrical or mechanical components to malfunction or operate in a less than optimal manner.

Traditionally, gaming machines have been designed as upright machines with displays positioned generally vertical or as inclined machines with displays tilted about 45 degrees from the horizontal. Both of these designs have facilitated viewing by players, but the upright machines make consumption of food or beverages by players difficult. Typically, food or beverage items are placed between machines or on nearby chairs. The inclined machines often have a horizontal platform in front of the tilted display where a player can place food or beverages. However, this horizontal area often includes a coin tray or other input/output devices, which can be contaminated by spilled food or beverages. One way that gaming machines have been designed to accommodate this problem has been to include drains or drain buckets. For instance, one or more drains can be placed at the bottom of the coin tray or at the base of the horizontal area. However, such solutions still require significant cleaning and maintenance by casino and gaming machine personnel.

Accordingly, it would be desirable to provide gaming machines with improved features to accommodate food and beverage consumption on or around the gaming machines.

### SUMMARY OF THE INVENTION

The techniques of the present invention address the above need by providing methods and apparatus for a gaming machine cocktail table. Various embodiments of the gaming machine cocktail table feature display screens that can face generally upward for viewing by two or more players seated proximate the cocktail table chassis. In some applications, a monolithic tabletop can be provided on the cocktail table chassis to cover components of the gaming machine, whereby player interaction with any of these gaming machine components is via the monolithic tabletop, thereby isolating the gaming machine components from environmental contamination and providing a surface upon which food and beverage items can be placed.

One aspect of this invention pertains to a gaming machine cocktail table. This gaming machine cocktail table may be characterized by the following features: (a) a cocktail table chassis; (b) two or more display screens mounted in the cocktail table chassis and facing generally upward for viewing by two or more players seated proximate the cocktail table chassis; and (c) a master gaming controller connected to each of the two or more display screens in a manner allowing the master gaming controller to control games presented on each of the two or more display screens.

Another aspect of this invention pertains to a gaming machine cocktail table that may be characterized by the following features: (a) a cocktail table chassis; (b) a display screen mounted in the cocktail table chassis and facing generally upward for viewing by a player seated proximate the cocktail table chassis; (c) a wireless credit device for receiving credit for game play; (d) a touch pad or touch screen for receiving player selections associated with said game play; and (e) a monolithic tabletop provided on the cocktail table chassis in a manner covering (b) though (d), whereby player interaction with any of (b) through (d) is via the monolithic tabletop, thereby isolating (b) through (d) from environmental contamination.

Yet another aspect of this invention pertains to a gaming machine cocktail table that may be characterized by the following features: (a) a cocktail table chassis; (b) a display screen mounted in the cocktail table chassis and facing generally upward for viewing by a player seated proximate the cocktail table chassis; and (c) an image redirect sheet, disposed on the display screen, for redirecting light emitted from said display screen in a direction generally toward where the player is expected to be seated.

Still another aspect of this invention pertains to a gaming machine cocktail table that may be characterized by the following features: a first display screen configured to display gaming information to a first player; a second display screen configured to display gaming information to a second player; and a master gaming controller coupled to the first display screen and the second display screen, wherein the master gaming controller is configured to control both the first display screen and the second display screen, and wherein the master gaming controller is configured to present a game of chance to each of the first display screen and the second display screen.

Another aspect of the invention pertains to a method of implementing a cashless transaction using a gaming machine cocktail table. Such method may be characterized by the following sequence of operations (typically implemented on a computing device): receiving player account information from a smart card device; presenting a game of chance on a first display screen of the gaming machine cocktail table during a gaming session, wherein the cocktail table includes: the first display screen configured to present a game of chance to a first player; a second display screen configured to present a game of chance to a second player; and a master gaming controller coupled to the first display screen and the second display screen, wherein the master gaming controller is configured to control both the first display screen and the second display screen, and wherein the master gaming controller is configured to present a game of chance to each of the first display screen and the second display screen; and communicating updated player account information on the smart card device upon termination of the gaming session.

Another aspect of the invention pertains to a method of providing a game of chance on a gaming machine that may be characterized by the following sequence of operations (typically implemented on a computing device): at a credit input device, receiving player account information from a smart card device separated from the credit input device by a transparent or semitransparent monolithic sheet; at a biometric identification device, receiving player biometric information from a player separated from the biometric identification device by the monolithic sheet; at a touch sensitive interface, receiving player input instructions from said player touching the monolithic sheet at locations over the touch sensitive interface; and displaying a game presentation to the player via a display covered by the monolithic sheet.

These and other features and benefits of the present invention will be described in more detail below with reference to the associated figures.

### BRIEF DESCRIPTION OF THE DRAWINGS

FIG. 1 is a diagrammatic representation of a gaming machine cocktail table.

FIG. 2 is a blow-apart diagram of an input/output assembly for a gaming machine cocktail table.

FIG. 3 is a flow diagram depicting a process for implementing a cashless gaming transaction using a gaming machine cocktail table.

FIGS. 4A and 4B are diagrammatic representations of a two-player gaming machine cocktail table.

FIG. 5 is a diagrammatic representation of a viewing angle associated with a two-player gaming machine cocktail table.

FIG. 6 is a block diagram of a display interface viewable on a gaming machine cocktail table.

FIG. 7 is a diagrammatic representation of a multi-player gaming machine cocktail table.

FIG. 8 is a diagrammatic representation of a multi-player gaming machine cocktail table formed as a counter.

FIG. 9 is another diagrammatic representation of a multi-player gaming machine cocktail table formed as a counter.

### DETAILED DESCRIPTION OF INVENTION

Within a casino or other gaming environment, it is common for players to consume food and/or beverages on or around the gaming machines even though such consumption can be inconvenient for the players and the casinos, as described above in the Background section. Specifically, the gaming machine may lack a level and conveniently accessible surface upon which food and beverage items can be placed, and spilled food or beverage products can cause the gaming machine to malfunction or require significant clean-up, resulting in downtime and possibly special servicing.

Accordingly, various embodiments of the present invention address the above problems and needs by providing a gaming machine cocktail table having a generally horizontal surface without openings for input/output devices or other gaming machine devices. Food and beverages can be placed on the surface of the gaming machine and any spillage can be wiped away easily. Furthermore, without openings in the generally horizontal surface, the risk of damaging internal components is significantly reduced.

In addition, various embodiments of the present invention overcome many difficulties presented by using a generally horizontal surface with a gaming machine. For instance, having a generally horizontal surface typically decreases a player's visibility of the screen and thereby creates an uncomfortable experience for the player. In addition, having a generally horizontal surface without openings typically makes player interaction with the gaming machine difficult because traditional input/output devices must either be eliminated or moved to inconvenient locations away from the playing surface of the gaming machine. Moreover, having a generally horizontal surface while preserving legroom for a player sitting in front of a machine typically decreases the amount of space available for housing gaming machine components. A related problem typically occurs if the gaming machine is designed to accommodate multiple players. Specifically, if multiple gaming machines are located together in an environment where food and beverages are served, such as a lounge, bar, or restaurant, players seated at different gaming machines may need to be spaced apart to accommodate the size of the respective gaming machine components. Because of the size of the gaming machines, the players may be seated further away from each other than they would be if seated at a traditional table or counter at an establishment such as a lounge, bar, or restaurant. Accordingly, various embodiments of the present invention address these problems and provide various benefits, as described in more detail below.

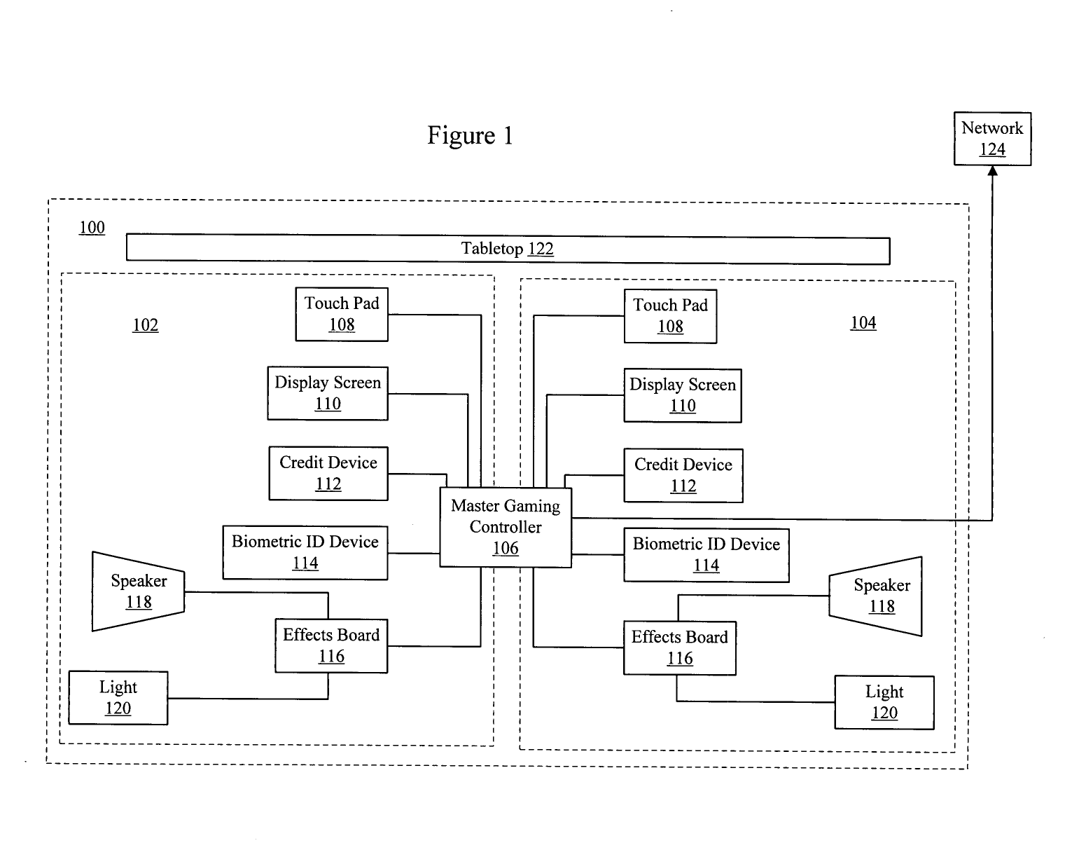

Turning now to FIG. 1, shown is a block diagram of one embodiment of a gaming machine cocktail table in accordance with the methods and apparatus of the present invention. In particular, the gaming machine cocktail table 100 shown can accommodate two players, who can either play two separate games of chance or an interactive game of chance with each another. For instance, two players can play two different games of chance presented simultaneously by the gaming machine. Another example includes two players playing poker with each other on the same gaming machine. Region 102 represents the gaming machine components devoted to presenting a game of chance to one player and region 104 represents the gaming machine components devoted to presenting a game of chance to another player.

In the present embodiment, tabletop 122 is a monolithic surface that can be transparent or semi transparent. This tabletop 122 protects the components of the gaming machine cocktail table from environmental contamination, such as spilled food or beverages, as well as dust and dirt. In some embodiments, the monolithic tabletop 122 is a glass sheet, having a thickness of at least about one-half inch. However, other materials having various thicknesses can be used, such as acrylic or plexiglass. In some embodiments, the monolithic tabletop can be a surface composed of multiple pieces, such as panels of glass or other materials, depending on the application. Furthermore, tabletop 122 can be formed in various shapes, depending on the application. Tabletop 122 can include ornamentation that is applied directly on its surface or near its top or bottom surface. For instance, ornamentation can be included on tabletop 122 by a process such as silkscreening, etching, frosting, painting, dying, or the like, and can include graphics, logos, patterns, a solid border, or the like. All or substantially all of a player's interaction with the gaming machine is through tabletop 122, as described in more detail below.

The master gaming controller 106 is used to present one or more games on the gaming machine 100. Specifically, the master gaming controller 106 executes a number of gaming software programs to operate gaming devices, which may be implemented as “peripheral” devices such as touch pads 108, display screens 110, credit devices 112, biometric identification devices 114, effects boards 116, speakers 118, lights 120, and any other gaming machine components that may be included. For a more detailed description of peripheral devices, see U.S. patent application Ser. No. 09/414,659, entitled “STANDARD PERIPHERAL COMMUNICATION,” by Stockdale et al., filed on Oct. 6, 1999, and U.S. patent application Ser. No. 10/097,507, entitled “VIRTUAL GAMING PERIPHERALS FOR A GAMING MACHINE,” by LeMay et al., filed on Mar. 12, 2002. Furthermore, master gaming controller 106 can present separate games of chance to different players. For instance, master gaming controller 106 can simultaneously present two different games of chance to two different players via two separate display screens 110. In another example, master gaming controller can present a single poker game to two players playing interactively with each other via two respective display screens 110.

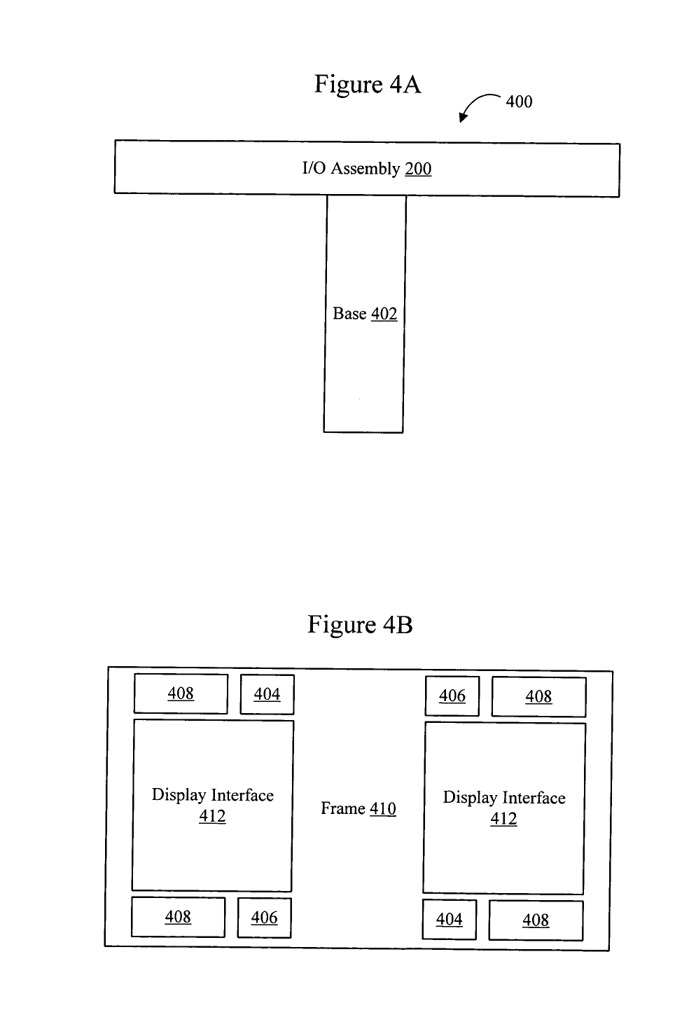

One or more display screens, such as 110, may be used with the gaming machine to display games of chance, or other gaming information such as advertisements, demos, teasers, and the like. These display screens can face generally upward for viewing by two or more players seated proximate the gaming machine 100. The one or more displays may be video displays, mechanical displays (e.g., slot reels), or combinations thereof. Preferably, the display screens are video displays such as LCD screens, and the like, that can fit into a cocktail table chassis, as described in more detail below with regard to FIG. 4. The master gaming controller 106 may execute gaming software enabling complex graphical renderings to be presented on the display screens 110 as part of a game outcome presentation on the gaming machine 100. The master gaming controller 106 may also execute gaming software enabling communications with gaming devices located outside of the gaming machine 100, such as player tracking servers and progressive game servers. For instance, gaming machine 100 can be connected to a network 124 that includes player tracking servers, progressive game servers, other gaming machine networks, and the like. Although network 124 is shown as having a direct connection to master gaming controller 106, it should be recognized that gaming machine 100 can be connected to network 124 through various mechanisms, such as via a communication board that provides an interface between master gaming controller 106 and network 124.

Touch pads 108 are located between display screens 110 and the players. Generally, these touch pads 108 are contactless devices that can be located beneath tabletop 122 in order to protect the instrumentation included in touch pads 108, but the touch pads 108 can also be located above tabletop 122 in some embodiments. These touch pads 108 can receive player input associated with game play on gaming machine 100. In particular, the activated regions of the touch pads 108 can receive input from a player when a player interrupts an electromagnetic field around the activated region, without the player having to contact the touch pads 108 directly. Accordingly, a player can touch the surface of a tabletop 122 that is within the activated region, or hover within the region to provide input to the gaming machine.

The touch pads 108 can be configured as one sheet that serves both regions 102 and 104 or as separate sheets that each serve their respective regions. Each touch pad 108 includes predetermined regions that can receive input from a player when they are activated. In particular, each of the various predetermined regions can act as one plate of a capacitor, which has an associated electromagnetic field with a frequency of, for example, between about 100-150 kHz.

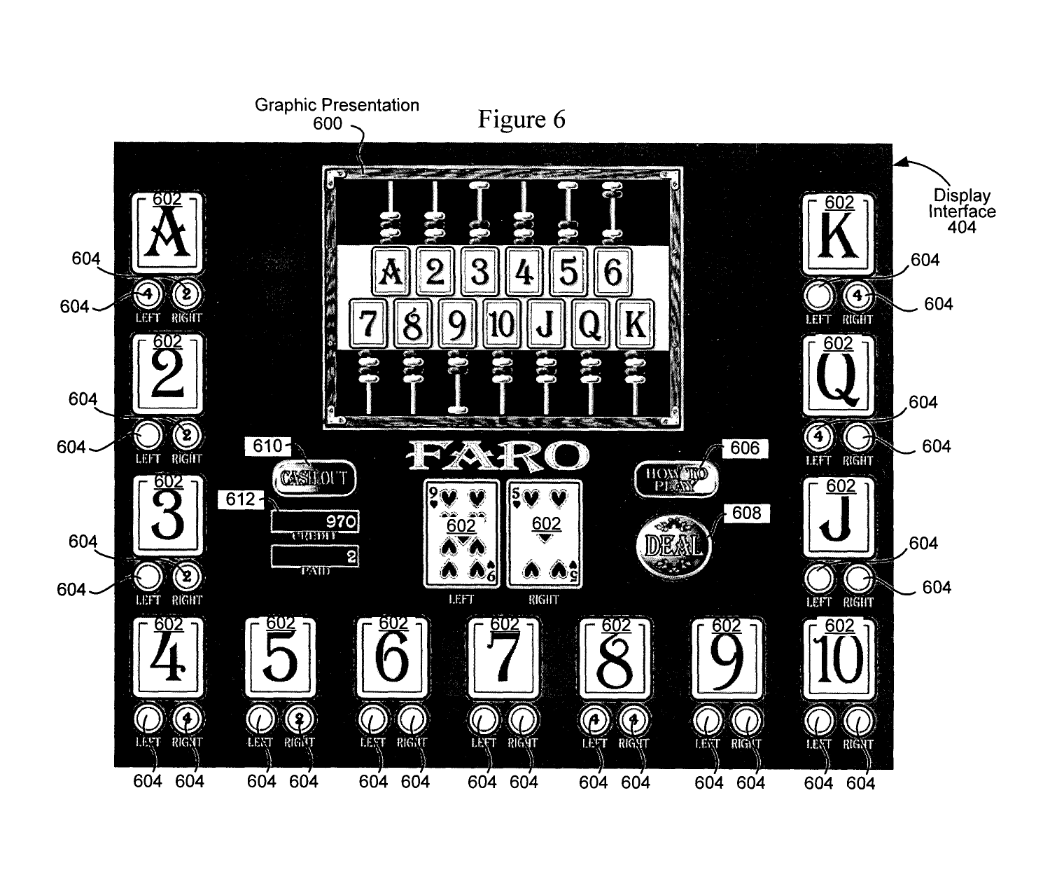

The various predetermined regions can be activated at various times by gaming machine 100, depending on the information being displayed on display screens 110. For instance, a “cash out” button can be activated between games and de-activated during game play such that gaming machine 100 ignores any contact with this button by the player while the game is in progress. One example of a display interface that uses these predetermined regions is shown in FIG. 6, as will be discussed in more detail below. Examples of touch pads that can be used with the methods and apparatus of the present invention are available from 3M Touch Systems (Maplewood, Minn.).

Although the present embodiment includes touch pads 120, it should be recognized that other input devices can be used in accordance with the present invention. For instance, a touch screen having capacitive microfilaments embedded within it can be used with the present invention. Although touch screens generally provide higher resolution than touch pads, touch screens generally allow detection of only one contact point at a time. If two or more contact points are detected by the touch screen, the touch screen will calculate the midpoint between the simultaneous contact points and use this midpoint as the input. Thus, a player can only touch one region of the board in order for the intended input to be accurate. An example of a touch screen that can be used with the methods and apparatus of the present invention is the I-Touch, available from Elo TouchSytems, Inc. (Fremont, Calif.). Other types of input devices can include X-Y grids constructed of wires that can detect the location of a player's contact with the grid, such as part number ZYT 18.4-004-TG, available from Zytronics Displays, Ltd. (Patterson Street, Blaydon On Tyne, Tyne and Wear NE21, 5SG).

In the present embodiment, the credit device 112 receives player account information as part of a cashless and contactless transaction with a player. Specifically, in one embodiment, credit device 112 receives credits or currency for game play from a portable player device such as a card or other device that is encoded with the credits or currency, without the portable player device having to contact the credit device 112 directly. In one instance, credit device 112 can be a contactless smart card reader that receives credits from a portable player device such as a smart card device when the smart card device is placed in proximity to the smart card reader. In this instance, the smart card device need not make contact with the smart card reader, and can communicate with the smart card reader through tabletop 122 when the smart card device is within about one inch of the smart card reader. Specifically, the smart card reader can emit an electromagnetic field that induces the smart card device to emit a signal when it is within proximity of the electromagnetic field. Accordingly, the smart card device can act as a passive device, which stores about 256 bits of memory. In other instances, the smart card device need not act as a passive device. According to various embodiments, credits are removed from the portable player device when they are received by the credit device 112. At the end of a gaming session, credits remaining on the gaming machine can be transferred from the credit device 112 to the portable player device.

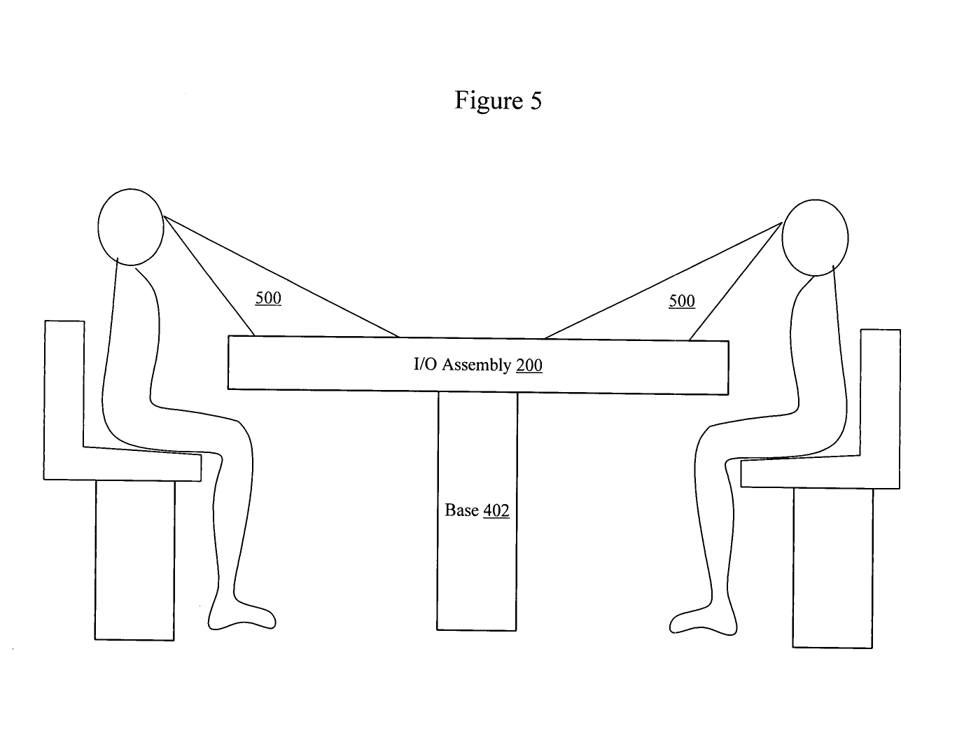

In other embodiments, a portable player device can store player account information such as a player identification number, player preferences, card value, and biometric information, as described in more detail below. The player identification number can be used to access a record stored in a database that includes player account information. By storing only a player identification number on the portable player device, the amount of memory needed for the portable player device can be reduced, thereby reducing the cost of the portable player device. The player preferences can include preferred games, color schemes, music, bet amounts, and the like. These player preferences can either be entered by a player or deduced by the gaming machine system based on the player's past patterns of play. According to various embodiments, the portable player device can be designed as a card, keychain, pendant, bracelet, and the like. For instance, the portable player device can be a player's card. In addition, credit device 112 can be designed to include ticket based capabilities (as provided by IGT's EZ Pay™ cashless system for example), as described in U.S. patent application Ser. No. 09/648,382, entitled “CASHLESS TRANSACTION CLEARINGHOUSE,” by Rowe, filed on Aug. 25, 2000, and U.S. patent application Ser. No. 10/406,911, entitled “CASHLESS TRANSACTION CLEARINGHOUSE,” by Rowe, filed on Apr. 2, 2003. For instance, credit device 112 can read information from a ticket issued by an EZ Pay™ ticket printer at the start of a gaming session. At the end of a gaming session, an EZ Pay™ ticket printer can issue a new ticket with updated player account information: The EZ Pay™ ticket printer can be located on the base 402 (see FIG. 5) of the gaming machine cocktail table or in some other convenient location. In other embodiments, both the EZ Pay™ ticket printer and reader can be located on the base 402 (see FIG. 5) of the gaming machine cocktail table or in some other convenient location.

Although a portable player device can store player account information that can be useful for establishing a gaming session, a portable player device does not provide true authentication of the player using the portable player device. In other words, it is possible for a person other than the valid holder of the portable player device to use it without detection by the credit device 112. Accordingly, biometric identification devices 114 are contactless devices that can be included in gaming machine 100 to authenticate a player using a portable player device. For instance, a biometric identification device 114 can identify a person to confirm that the person's identity matches the biometric information that is either stored on a portable player device or associated with the portable player device, such as by a player identification number. In addition, the biometric information can be used to identify high rollers, known “cheaters,” or other note-worthy players. Once a player is identified, the gaming machine can either configure which games to present, refuse game play, notify casino personnel, or perform any other appropriate function. As part of configuring the games, bet values and other preferences can be selected by the gaming machine based on the identity of the player. In some embodiments, the biometric identification device 114 can be used in lieu of credit device 112. Specifically, biometric information can be used as a player identification number to locate records associated with a particular player. In the present embodiment, the biometric identification device 114 is used in conjunction with credit device 112.

Biometric identification device 114 can be a device that does not require direct contact with a player such as an eye recognition device, a facial recognition device, a fingerprint device, or the like, or combinations thereof. For instance, if an eye recognition device is used, an infrared light source, such as an LED, can be located in a region viewable through tabletop 122. When a player looks at the infrared light source, the infrared light source illuminates the player's eye. An eye scanner, which is sensitive to the infrared spectrum can then react to the illumination of the player's eye and can detect a pattern, such as a pattern in the player's iris. This pattern can then be compared with information either stored on a portable player device or associated with the portable player device, such as by a player identification number. If the information matches, then the player is authenticated. An example of an eye scanner that can be used in conjunction with various embodiments of the present invention is available from Panasonic (Secaucus, N.J.), part number BM-ET100US.

In another example, a facial recognition device can be used to authenticate a player using biometric information. In order to identify the player based on facial features, the alignment of the player's face with respect to the gaming machine can first be calibrated. To calibrate the alignment of the player's face, an infrared light source, such as an LED, can be located in a region viewable through tabletop 122. When the player looks at the infrared light source, the infrared light source illuminates the player's eye. An eye scanner, which is sensitive to the infrared spectrum can then detect two red reflections corresponding to the player's eyes. The spacing of the two red dots can then be used to calibrate the alignment of the player's face with respect to the light source. Next, the facial recognition device can scan the player's facial features. Using an algorithm, this information can then be compared with information either stored on a portable player device or associated with the portable player device, such as by a player identification number. If the information matches, then the player is authenticated. Although the present example includes using an eye scanner, etc., other features and processes can be used to conduct facial recognition as well. Facial recognition devices that can be used in conjunction with various embodiments of the present invention are available from IGT (Reno, Nev.).

Other biometric identification devices, such as fingerprint devices, etc., can also be used to authenticate a player. An example of a fingerprint device that can be used with various embodiments of the present invention is available from Digital Persona (Redwood City, Calif.), part number U.ARE U.4000.

To enhance a player's experience and to encourage game play, visual and audio effects can be coordinated with game play, player interaction, demos, teasers, and the like. The visual and audio effects can also be designed to provide the player with feedback based on the player's interaction with the gaming machine. For instance, when the player terminates a gaming session with the gaming machine, the gaming machine can provide sounds and visuals that indicate that credits or prizes are being awarded. Effects board 116 can be used in conjunction with master gaming controller 106 to synchronize speakers 118 and lights 120 with each other, game play, player interaction, demos, teasers, and the like, or any combinations thereof. In some embodiments, a light organ concept can be used to coordinate particular frequencies of the lights with particular musical notes emitted from the speakers. For instance, the higher the amplitude, the brighter the light. Furthermore, lower frequencies can be associated with red light, higher frequencies can be associated with white light, and intermediate frequencies can be associated with blue green lights. This feature can be implemented with an appropriate group of band pass filters, each associated with a different color. In some embodiments, the left channel can be dedicated to one player while the right channel is dedicated to the other player. Moreover, in some embodiments, the lights can be used without sound, or sound can be used without lights. Furthermore, the lights and sound may not be coordinated at all times.

Speakers 118 can amplify various sounds such as music, sound effects, and the like. Furthermore, speakers 118 can be of any kind, such as traditional speakers or a sound card. One example of a speaker that can be used with various embodiments of the present invention is available from Regal Electronics, Inc. (Sunnyvale, Calif.), part number RH-36-E. Lights 120 can produce various effects such as blinking, strobing, illuminating characters or pictures, scrolling, and the like. Furthermore, various colors of lights can be used. Lights 120 can be LEDs, incandescent bulbs, fluorescent bulbs, luminescent display elements, light emitting interface displays, and the like. Various examples of luminescent display elements are described in more detail in U.S. Pat. No. 6,027,115, entitled “Slot Machine Reels Having Luminescent Display Elements” by Griswold et al., issued on Feb. 22, 2000, which is incorporated herein in its entirety for all purposes. In addition, light emitting interface displays are described in more detail in U.S. patent application Ser. No. 10/139,801, entitled “Light Emitting Interface Displays for a Gaming Machine” by Winans et al., filed on May 3, 2002, which is also incorporated herein in its entirety for all purposes. Other types of lights can also be used without departing from the scope of the methods and apparatus of the present invention.

Although the present embodiment has been described in conjunction with a two-player gaming machine cocktail table, it should be recognized that the gaming machine cocktail table can be designed for any number of players, including one player or multiple players.

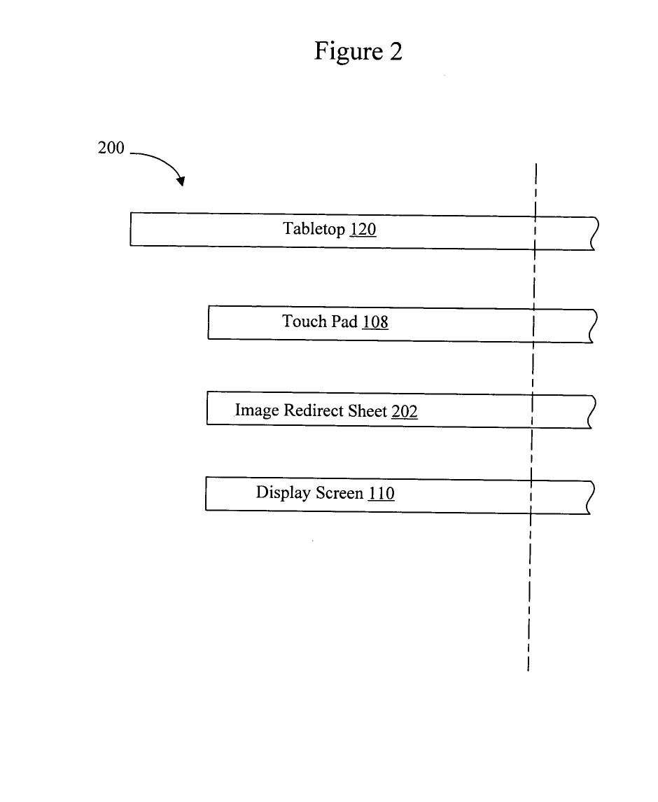

With reference to FIG. 2, shown is a blow-apart diagram of an input/output assembly for a gaming machine cocktail table. As described above with regard to FIG. 1, tabletop 120, touch pad 108 and display screen 110 allow a player to interact with gaming machine 100. In particular, display screen 110 displays gaming information to a player through tabletop 120, and touch pad 108 receives input from a player through tabletop 120. In addition to these features, the input/output assembly 200 can include an image redirect sheet 202 that shifts the viewing angle of display screen 110 in a direction generally toward where a player is expected to be seated, such that display screen 110 need not be inclined in order for a player to comfortably view the display screen 110. Specifically, as shown in FIG. 5, a player can comfortably view a display screen 110 in input/output assembly 200 at viewing angle 500. In one example, image redirect sheet 202 shifts the viewing angle of display screen 110 about 20 degrees from the generally vertical direction in order to accommodate various players of differing heights. By shifting the viewing angle of the display screen 110, a player can comfortably view the display screen 110 without having to lean over the input/output assembly 200 or otherwise physically strain. One example of an image redirect sheet that can be used is Image Directing Film, which is available from 3M Corporation, St. Paul, Minn. In addition to improving the comfort of a player viewing display screen 110, image redirect sheet 202 can increase the brightness of display screen 110, increase the uniformity of light emanating from display screen 110, and decrease the amount of power needed to effectively operate the input/output assembly 200. Although in one preferred embodiment, image redirect sheet 202 is placed as close as possible to display screen 110 in order to more effectively redirect the viewing angle of display screen 110, the components of input/output assembly 200 can be arranged in various configurations depending on the application. Furthermore, additional layers and components can be added without departing from the scope of the present invention. Additionally, although image redirect sheet 202 is not shown in FIG. 1 for simplicity, it should be recognized that image redirect sheet can be included in the gaming machine 100 shown in FIG. 1.

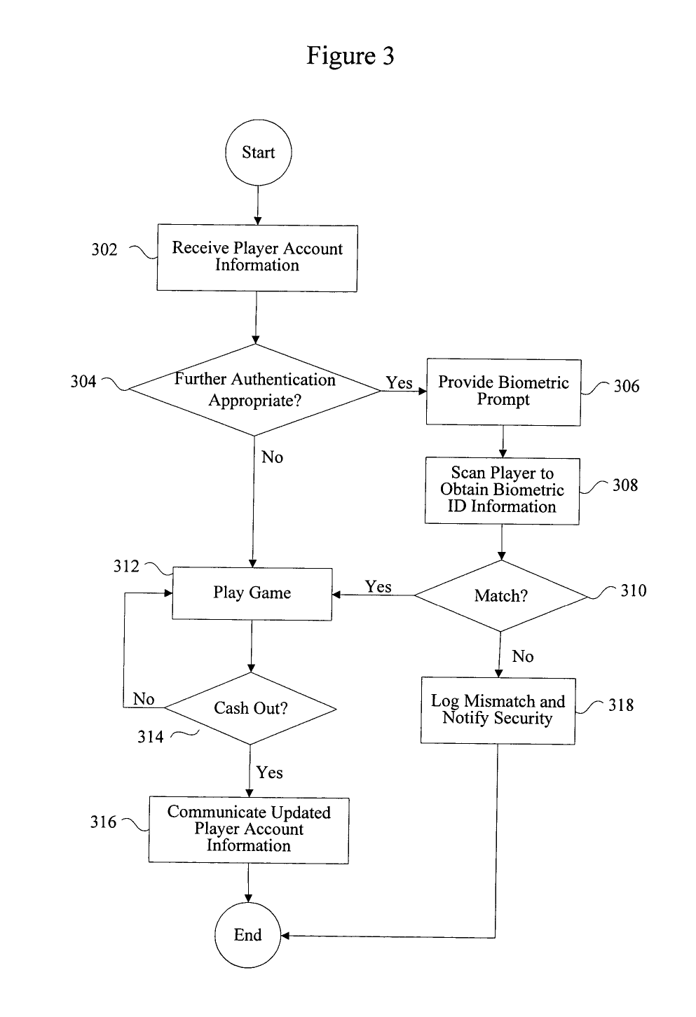

With reference to FIG. 3, shown is a flow diagram depicting a process for implementing a cashless gaming transaction with a gaming machine. In particular, a gaming session begins at 302 when gaming machine 100 receives player account information. As described above, player account information can include information such as player identification number, player preferences, card value, and biometric information. From this information, the gaming machine can set up preferred games, bet amounts, themes, ornamentation such as colors, and other preferences for the player associated with the player account information. As described above, detailed player account information can be stored on a portable player device or stored in a database that is searchable using a player identification number from the portable player device. In other embodiments, the player can input information such a player identification number or other identifier without the use of a portable player device to input player account information.

Once player account information is received, then at 304, the player account information is compared to authentication criteria to determine if further authentication of player identity is appropriate. Any kind of authentication criteria can be used depending on the application. For example, if the authentication criteria includes a list of player identification numbers corresponding to high rollers, then the player identification number associated with the player account information is compared to this list. If the player identification number appears on the list, then further authentication is appropriate. Another example of authentication criteria includes a threshold number of credits at or above which further authentication is appropriate. Accordingly, if the player account information indicates that the number of credits available equals or exceeds this threshold number of credits, then further authentication is appropriate. Otherwise, further authentication is not necessary and the gaming session can proceed at 312.

If further authentication is appropriate, then at 306 a biometric prompt is provided. For instance, if a retina scan is used, a light, sound, or other prompt can instruct a player to look towards an infrared LED that is located in a region viewable through tabletop 122. Any type or combination of prompts can be used such as instructions viewable on display screen 100, audio instructions audible through speakers 118, or the like. Once the biometric prompt is provided, then at 308, biometric identification information is obtained by scanning the player. As described above, various forms of biometric identification information can be obtained. For instance, a retina scanner, an iris scanner, a facial recognition device, a fingerprint device, or the like, or combinations thereof can be used to obtain biometric identification information. After the biometric identification information is obtained from the player, then at 310, it is determined whether the biometric identification information obtained matches biometric information stored on the portable player device or in a record associated with the portable player device. For instance, if a fingerprint scan is used, the fingerprint obtained by the gaming machine is compared to a stored fingerprint for the valid player associated with the portable player device. If the biometric identification information obtained matches the stored biometric information, then at 312 the gaming machine presents a game of chance to player. Otherwise, the gaming session can be terminated or the biometric prompt at 306 can be provided again, depending on the application. Typically, the failure to match will be logged and reported in conjunction with the player's account. See 318. For instance, the failure to match can be logged as part of the player account information, or in a separate database. In some cases, security personnel may be notified as well.

Once a game of chance is presented at 312, the player can interact with the gaming machine and continue game play. At 314, if either the player or the gaming machine initiates cash out, then at 316, updated player account information is communicated to the player's portable player device or any other medium for storing player account information, such as a database. For instance, the number of available credits after game play can be uploaded onto the player's portable player device. In some embodiments, credit device 112 (FIG. 1) can verify that the portable player device presented by the player at 316 corresponds to the same portable player device presented at 302 before uploading the available credits onto the portable player device. Once the updated player account information is communicated to the player's portable player device or any other medium for storing player account information, then the gaming session is terminated.

With reference to FIGS. 4A and 4B, shown are diagrammatic representations of an exemplary two-player gaming machine cocktail table. Specifically, FIG. 4A depicts a side view of an embodiment of a two player gaming machine cocktail table. In this side view, a cocktail table chassis 400 can be used to house components of a gaming machine 100 (FIGS. 1 and 2). The cocktail table chassis 400 includes a housing for input/output assembly 200 and base 402. Although input/output assembly 200 and base 402 are shown a separate boxes in FIG. 4A, it should be recognized that they can be featured as one unit. Specifically, although the input/output assembly 200 can be housed in the top portion of the cocktail table chassis 400, any of the components of gaming machine 100 can be rearranged within the cocktail table chassis depending on the application. As shown, the cocktail table chassis includes space around base 402 that can provide legroom for players in either a seated or standing position. Furthermore, this space facilitates easy cleanup of the space beneath the gaming machine cocktail table 100. The cocktail table chassis can be constructed of any material, including metal, wood, plastic, and the like, depending on the application.

FIG. 4B depicts a top view of one embodiment of a two player gaming machine cocktail table. Specifically, FIG. 4B shows a player interface having a frame 410 included on it by a process such as silkscreening, etching, frosting, painting, dying, or the like, or laid below or above the surface of the tabletop. Frame 410 can include graphics, logos, patterns, a solid border, or the like. Frame 410 provides a border that defines display interface 412, biometric identification device interface 404, credit interface 406, and light interface 408. Display interface 412 is a region through which display screen 110 is viewable by a player. Furthermore, the gaming machine cocktail table can receive input from a player through display interface 412. Biometric identification device interface 404 is a region through which biometric identification information can be obtained from a player, as described more detail above. In addition, biometric prompts, such as LED lights and the like, can be viewable by a player through biometric identification device interface 404 in some embodiments. Credit interface 406 is a region through which credit device 112 can interact with a portable player device, such as a smart card, as described in more detail above. Specifically, information can be passed between credit device 112 and the portable player device when the portable player device is placed in proximity to or in contact with the credit interface 406. Light interface 408 is a region through which lights 120, or any other visual effects, are viewable by a player. For example, LEDs can be directly viewable through light interface 408, viewable via one or more metallic tunnels placed between the LEDs and light interface 408 in order to magnify the effect of the LEDs, or viewable through a translucent sheet. In other embodiments, light emitting interface displays or other light sources can be viewable through light interface 408.

In the present embodiment, the gaming machine cocktail table is configured for two players that are located at opposite ends, such that they face each other. For each of the two players, a display interface 412 is located directly in front of him or her, biometric identification device interface 404 and light interface 408 are located to the player's left hand side, and credit interface 406 and light interface 408 are located to the player's right hand side. As used in this application a player interface refers to the set of interfaces dedicated to a player such as a display interface 412, biometric identification device interface 404, credit interface 406, and light interface 408. It should be recognized that any combination of interfaces can be included in a player interface depending on the application. As described in more detail below, one or more player interfaces can be included on a gaming machine cocktail table in various configurations.

With reference to FIG. 5, shown as a diagrammatic representation of an exemplary viewing angle associated with the two player gaming machine cocktail table. As shown, a player seated proximate a gaming machine cocktail table can comfortably view a display screen 110 in input/output assembly 200 at viewing angle 500. As described above with regard to FIG. 2, an image redirect sheet 202 can be used to shift the viewing angle of a display screen 110 located within input/output assembly 200 or otherwise within gaming machine chassis 400 (FIG. 4) about 20 degrees from the generally vertical direction in order to accommodate various players of differing heights. By shifting the viewing angle of the display screen 110, a player can comfortably view the display screen 110 without having to lean over the input/output assembly 200 or otherwise physically strain.

With reference to FIG. 6, shown as a block diagram of one embodiment of a display interface viewable on a gaming machine cocktail table. In this embodiment, display interface 404 (FIG. 4) includes a graphic presentation area 600, cards 602, action buttons 604, help button 606, deal button 608, cash out button 610, and credits display 612. Graphic presentation area 600 can present various features for a game of chance, such as a virtual dealer, spinning reels, a spinning roulette table, and the like. Furthermore graphic presentation area 600 can be either an active or inactive region for player input. Cards 602 can each display a playing card as part of a game of chance. Action buttons 604 can be active regions that allow player to input instructions such as hit or stand for games such as blackjack, or otherwise interact with gaming machine through display interface 404. Help button 606 can be an active region that is selectable by a player. When a player selects help button 606, a new screen can appear through display interface 404 that provides information about the game of chance being presented, or other information requested by the player. Deal button 608 can also be an active region that is selectable by a player. When a player selects the deal button 608, a new card hand can be dealt to the player. During game play, deal button 608 may become inactive at various times, such as when dealing a new hand is inappropriate during certain phases of the game. Cash out button 610 is yet another active region that is selectable by a player. After a player selects cash out button 610, a gaming session can be terminated by the gaming machine. In particular, with reference to FIG. 3, selection of cash out button 610 by a player occurs between items 314 and 316. Cash out button 610 may become inactive at various times, such as during game play. Furthermore cash out button 610 may become active at various times, such as between card hands or between separate presentations of games of chance. Although FIG. 6 depicts a particular embodiment of a display screen having a configuration of active regions, it should be recognized that any configuration of active regions can be presented depending on the game of chance offered or the gaming information displayed.

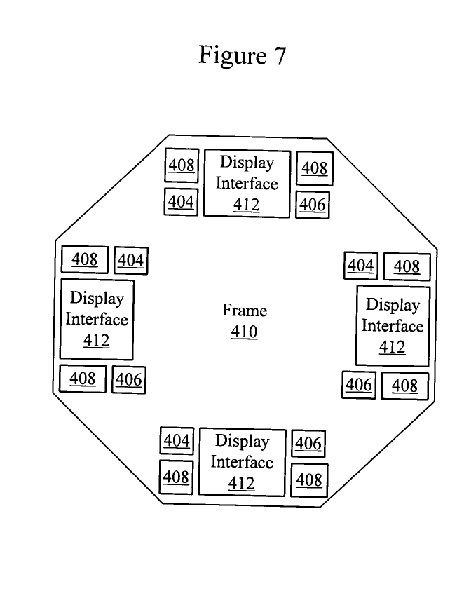

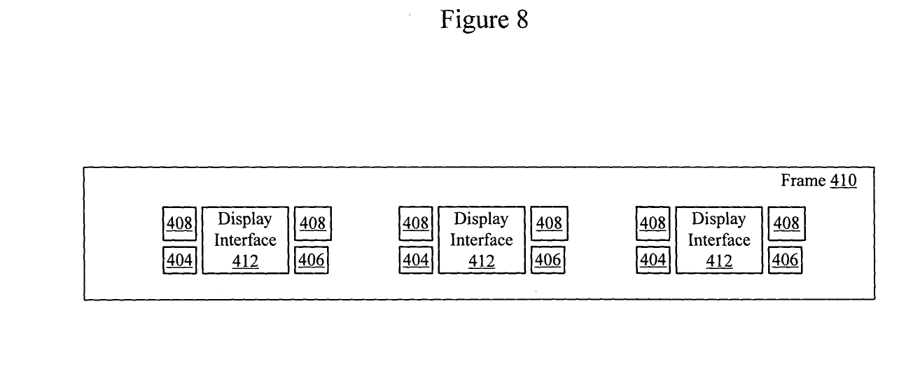

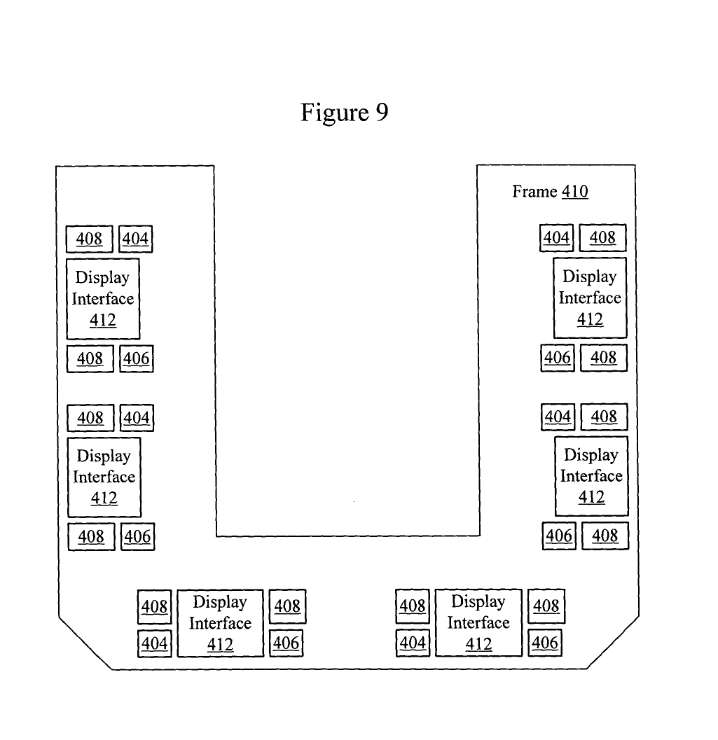

As described above, a gaming machine cocktail table can be configured for any number of players. Furthermore, the gaming machine cocktail table can be configured in any shape or size depending on the application. With reference to FIG. 7, a diagrammatic representation of one embodiment of a multiplayer gaming machine cocktail table is shown from a top view. In particular, this embodiment includes an octagonal tabletop configured for four players, but it can be configured for any number of players. FIG. 8 shows another diagrammatic representation of an embodiment of a multiplayer gaming machine cocktail table shown from a top view. In this embodiment, the gaming machine cocktail table is configured as a counter that can be used as a bar top, a restaurant counter, or the like. In addition, the counter can face a wall, window, a stage or show, or the like. In some embodiments, counters can be lined up to face a stage, such as in a theater, or in a lecture hall. The counter shown in the present embodiment is configured for three players facing the same direction, but it can be configured for any number of players. FIG. 9 shows yet another diagrammatic representation of an embodiment of a multiplayer gaming machine cocktail table shown from a top view. In this embodiment, the gaming machine cocktail table is also configured as a counter that is generally shaped in the form of a horseshoe. As with the counter described with regard to FIG. 8, the counter that can be used as a bar top, a restaurant counter, or the like. In addition, the counter can face a wall, window, a stage or show, or the like. The counter shown in the present embodiment is configured for six players generally facing toward the center of the horseshoe shape, but it can be configured for any number of players. In some embodiments, this counter can be enclosed to form a rectangular or circular shape. Although particular exemplary embodiments are shown in FIG. 7 through 9, it should be recognized that the gaming machine cocktail table can be formed in any shape or size and can accommodate any number of players. For instance, a gaming machine cocktail table can be designed for players sitting or standing near the gaming machine.

Various embodiments of the methods and apparatus described in accordance with the present invention provide various benefits. For instance, various embodiments of the gaming machine cocktail table described in the present application have a generally horizontal surface without openings for input/output devices or other gaming machine devices. Food and beverages can be placed on the surface of the gaming machine and any spillage can be wiped away easily. Furthermore, without openings in the generally horizontal surface, the risk of damaging internal components is significantly reduced.

Furthermore, including an image redirect sheet 202 (FIG. 2) in conjunction with a display screen 110 in some embodiments generally increases a player's visibility of the display screen 110 and thereby increases a player's comfort while interacting with a gaming machine 100. In addition, providing various input/output devices to facilitate cashless transactions between a gaming machine 100 and a player allows a monolithic tabletop to be used with a gaming machine thereby protecting the internal components of the gaming machine from contamination, while providing a convenient interface for interactions between the player and gaming machine.

Moreover, by using a master gaming controller 106 (FIG. 1) to present games of chance simultaneously to two or more players that are playing separately or interactively, the amount of space required for gaming machine components within a cocktail table chassis can be reduced, thereby allowing the gaming machine cocktail table to provide ample legroom for players, as well as comfortable spacing between players in a traditional table, counter, or other configuration at an establishment such as a lounge, bar, or restaurant. Additionally, in jurisdictions having limitations on the number of gaming machines, having a single master gaming controller can provide increased player capacity. Specifically, whereas a single master gaming controller is traditionally configured to present a game of chance to a single player, a master gaming controller as described in conjunction with the methods and apparatus of the present invention can present games of chance to one or more players, depending on the application. Accordingly, casinos and other gaming facilities can increase their player capacity by using gaming machines having such master gaming controllers, as well as reduce the costs per player of providing games of chance in their establishments.

Although specific benefits have been described in conjunction with various embodiments of the present invention, it should be recognized that additional benefits can exist and that no specific benefits, even those enumerated herein, are required of any particular embodiment of the methods or apparatus of the present invention.

### CONCLUSION

Although the above generally describes the present invention according to specific exemplary processes and apparatus, various modifications can be made without departing from the spirit and/or scope of the present invention. Therefore, the present invention should not be construed as being limited to the specific forms shown in the appended figures and described above.

1. A gaming machine comprising:
(a) a cocktail table chassis;
(b) two or more display screens mounted in the cocktail table chassis and facing generally upward for viewing by two or more players seated proximate the cocktail table chassis; and
(c) a master gaming controller connected to each of the two or more display screens in a manner allowing the master gaming controller to control games presented on each of the two or more display screens.

2. The gaming machine of claim 1, comprising exactly two of the display screens.

3. The gaming machine of claim 1, further comprising two or more touch pads or touch screens, overlaid on the two or more display screens, for receiving player selections associated with game play on the gaming machine.

4. The gaming machine of claim 1, further comprising an image redirect sheet disposed on at least one of the display screens for redirecting light emitted from the at least one display screen in a direction generally toward where a player is expected to be seated.

5. The gaming machine of claim 1, further comprising a credit device mounted in the cocktail table chassis for receiving credit for game play.

6. The gaming machine of claim 1, further comprising a biometric identification device mounted in the cocktail table chassis.

7. The gaming machine of claim 1, further comprising a monolithic tabletop provided on the cocktail table chassis, whereby all player interface with the gaming machine is through the monolithic tabletop.

8. A gaming machine cocktail table comprising:
(a) a cocktail table chassis;
(b) a display screen mounted in the cocktail table chassis and facing generally upward for viewing by a player seated proximate the cocktail table chassis;
(c) a wireless credit device for receiving credit for game play;
(d) a touch pad or touch screen for receiving player selections associated with the game play; and
(e) a monolithic tabletop provided on the cocktail table chassis in a manner covering (b) though (d), whereby player interaction with any of (b) through (d) is via the monolithic tabletop, thereby isolating (b) through (d) from environmental contamination.

9. The gaming machine of claim 8, further comprising a master gaming controller located within cocktail table chassis and thereby protected from the environmental contamination by the monolithic tabletop.

10. The gaming machine of claim 8, wherein the monolithic tabletop is transparent or semitransparent.

11. The gaming machine of claim 8, wherein the monolithic tabletop comprises a monolithic glass sheet.

12. The gaming machine of claim 11, wherein the glass sheet is at least about one-half inch thick.

13. The gaming machine of claim 8, further comprising a non-contact biometric identification device covered by the monolithic tabletop, wherein the non-contact biometric identification device is configured to obtain biometric identification information from a player.

14. The gaming machine of claim 8, further comprising a second display screen mounted in the cocktail table chassis and facing generally upward for viewing by a second player seated proximate the cocktail table chassis.

15. The gaming machine of claim 8, wherein the wireless credit device is a smart card reader that can transmit and receive credit information.

16. A gaming machine comprising:
(a) a cocktail table chassis;
(b) a display screen mounted in the cocktail table chassis and facing generally upward for viewing by a player seated proximate the cocktail table chassis; and
(c) an image redirect sheet, disposed on the display screen, for redirecting light emitted from the display screen in a direction generally toward where the player is expected to be seated.

17. The gaming machine of claim 16, wherein the display screen is an LCD screen.

18. The gaming machine of claim 16, further comprising a touch pad or touch screen, disposed on the image redirect sheet on a side opposite the display screen, for receiving player selections associated with game play on the gaming machine.

19. The gaming machine of claim 18, further comprising a transparent or semitransparent tabletop disposed above the touch pad or touch screen on a side opposite the image redirect sheet.

20. The gaming machine of claim 19, wherein the tabletop is a monolithic sheet isolating the display screen from environmental contamination.

21. The gaming machine of claim 16, further comprising a credit device mounted in the cocktail table chassis for receiving credit for game play.

22. The gaming machine of claim 16, further comprising a biometric identification device mounted in the cocktail table chassis.

23. A gaming machine cocktail table, comprising:
a first display screen configured to display gaming information to a first player;
a second display screen configured to display gaming information to a second player; and
a master gaming controller coupled to the first display screen and the second display screen, wherein the master gaming controller is configured to control both the first display screen and the second display screen, and wherein the master gaming controller is configured to present a game of chance to each of the first display screen and the second display screen.

24. The gaming machine cocktail table of claim 23, further comprising a monolithic tabletop configured to form an interface between the first player and the first display screen and between the second player and the second display screen.

25. The gaming machine cocktail table of claim 24, wherein the tabletop is configured to isolate the display screens from environmental contamination.

26. The gaming machine cocktail table of claim 24, wherein the tabletop is transparent.

27. The gaming machine cocktail table of claim 24, further comprising an image redirect sheet associated with the monolithic tabletop, wherein the image redirect sheet is configured to allow the first player to view information displayed on the first interactive display screen without inclining the first interactive display screen.

28. The gaming machine cocktail table of claim 23, further comprising a touch pad or touch screen situated between the first player and the first display screen, wherein the touch pad or touch screen is configured to receive input from the first player to facilitate interactive play between the first player and the game of chance.

29. The gaming machine cocktail table of claim 28, wherein the touch pad includes predetermined regions configured to receive input from the first player, wherein the predetermined regions can be activated in any combination at various times by the master gaming controller, and wherein an activated region can receive input from the first player when the first player interrupts an electromagnetic field around the activated region.

30. The gaming machine cocktail table of claim 23, further comprising a credit device.

31. The gaming machine cocktail table of claim 30, wherein the credit device is configured to read information from a smart card when the smart card is placed in proximity to the credit device.

32. The gaming machine cocktail table of claim 30, wherein the credit device is a smart card reader used to facilitate a cashless transaction between the first player and the gaming machine cocktail table, and wherein information can be transferred between a smart card and the smart card reader.

33. The gaming machine cocktail table of claim 23, further comprising a biometric identification device coupled to the master gaming controller, wherein the biometric identification device is configured to acquire biometric information from the first player.

34. The gaming machine cocktail table of claim 33, wherein the biometric information is used to identify the first player.

35. The gaming machine cocktail table of claim 33, wherein the biometric identification device is chosen from the group consisting of a retina scanner, an iris scanner, a facial recognition device, a fingerprint device, and any combination thereof.

36. The gaming machine cocktail table of claim 23, further comprising lights configured to operate in synchronization with a game of chance presented on the display screens.

37. The gaming machine cocktail table of claim 23, further comprising speakers configured to operate in synchronization with a game of chance presented on the display screens.

38. The gaming machine cocktail table of claim 23, further comprising a combination of lights and speakers configured to operate in synchronization.

39. The gaming machine cocktail table of claim 38, wherein the lights and speakers are configured to provide feedback to the first player as the first player interacts with the cocktail table.

40. The gaming machine cocktail table of claim 23, wherein the first display screen and the second display screen present separate games of chance to the first player and the second player.

41. The gaming machine cocktail table of claim 23, wherein the first interactive display screen and the second interactive display screen present an interactive game of chance to the first player and the second player, wherein the first player and second player interact with each other and the cocktail table.

42. A method of implementing a cashless transaction using a gaming machine cocktail table, the method comprising:
receiving player account information from a smart card device;
presenting a game of chance on a first display screen of the gaming machine cocktail table during a gaming session, wherein the cocktail table includes:
the first display screen configured to present a game of chance to a first player;
a second display screen configured to present a game of chance to a second player; and
a master gaming controller coupled to the first display screen and the second display screen, wherein the master gaming controller is configured to control both the first display screen and the second display screen, and wherein the master gaming controller is configured to present a game of chance to each of the first display screen and the second display screen; and
communicating updated player account information on the smart card device upon termination of the gaming session.

43. The method of claim 42, further comprising:
comparing the player account information to authentication criteria to determine if further authentication of player identity is appropriate,
wherein the player account information includes an amount of available credits and stored biometric information for the valid smart card holder, and
wherein the authentication criteria includes criteria for requiring further authentication of player identity;
providing a biometric prompt if the comparison indicates that further authentication is appropriate;
biometrically scanning a player associated with the smart card device to obtain biometric identification information for the player in response to the biometric prompt; and
determining if the biometric identification information matches the stored biometric information before presenting a game of chance.

44. The method of claim 43, wherein the authentication criteria includes a list of player identification numbers for which further authentication is appropriate.

45. The method of claim 43, wherein the authentication criteria includes a threshold number of credits at or above which further authentication is appropriate.

46. The method of claim 42, further comprising:
retrieving a record corresponding to the player account information received, wherein the retrieved record includes an amount of available credits and stored biometric information for the valid smart card holder;
comparing the retrieved record to authentication criteria, wherein the authentication criteria includes criteria for requiring further authentication of player identity;
providing a biometric prompt if the comparison indicates that further authentication is appropriate;
biometrically scanning a player associated with the smart card device to obtain biometric identification information for the player in response to the biometric prompt; and
determining if the biometric identification information matches the stored biometric information before presenting a game of chance.

47. The method of claim 46, wherein the authentication criteria includes a list of player identification numbers for which further authentication is appropriate.

48. The method of claim 46, wherein the authentication criteria includes a threshold number of credits at or above which further authentication is appropriate.

49. A method of providing a game of chance on a gaming machine, the method comprising:
at a credit input device, receiving player account information from a smart card device separated from the credit input device by a transparent or semitransparent monolithic sheet;
at a biometric identification device, receiving player biometric information from a player separated from the biometric identification device by the monolithic sheet;
at a touch sensitive interface, receiving player input instructions from the player touching the monolithic sheet at locations over the touch sensitive interface; and
displaying a game presentation to the player via a display covered by the monolithic sheet.
